(19) United States
(12) Patent Application Publication
(10) Pub. No.: US 2021/0388205 A1
(43) Pub. Date: Dec. 16, 2021

(54) A STAIN-RESISTANT POLYAMIDE COMPOSITION

(71) Applicant: DSM IP ASSETS B.V., Heerlen (NL)

(72) Inventors: Xin LIU, Echt (NL); Lidong ZHENG, Echt (NL); Ruogu LIAO, Echt (NL)

(21) Appl. No.: 17/289,459

(22) PCT Filed: Oct. 31, 2019
(86) PCT No.: PCT/EP2019/079883

§ 371 Date: Apr. 28, 2021

(30) Foreign Application Priority Data
Nov. 2, 2018 (CN) PCT/CN2018/113650
Jan. 31, 2019 (EP) 19154798.3

(51) Int. Cl. C08L 77/06

(52) U.S. Cl. CPC C08L 77/06; C08L 2203/20; C08L 2205/025; C08L 2205/035

(57) ABSTRACT

Present application disclosed a stain-resistant polyamide composition comprising, a) 55-80 wt. % of semi-crystalline semi-aromatic polyamide; b) 5-15 wt. % of aliphatic polyamide; c) 15-30 wt. % of amorphous semi-aromatic polyamide; wherein the weight percentages of a), b) and c) are relative to the total weight of a), b) and c) and the sum of the weight percentages of a), b) and c) is 100 wt. %; and wherein the semi-crystalline semi-aromatic polyamide comprises repeat units derived from condensation of terephthalic acid and at least one aliphatic diamine having more than 8 and less than 12 carbon atoms.

Present invention relates to a stain-resistant polyamide composition, especially relates to a stain-resistant polyamide composition comprising at least one semi-crystalline semi-aromatic polyamide, at least one aliphatic polyamide and one amorphous semi-aromatic polyamide.

Semi-crystalline semi-aromatic polyamide such as those derived from terephthalic acid and aliphatic diamines having excellent mechanical, physical and chemical properties which make them useful for a wide variety of different application. In particular, the semi-crystalline semi-aromatic polyamides are good candidates for the manufacture of articles such as portable electronic devices. Portable electronic devices, such as mobile telephones, personal digital assistant laptop and the like becoming increasingly widely used globally in many different environments. It is often desirable that those material have good stiffness and high impact resistance, exhibit high dimensional stability when they are formed into housing. Many attempts have been made to offer a polyamide material suitable for the manufacture of portable electronic devices housings. However, these materials still suffer from a significant drawback: they are not resistant to the staining agents that are often put in contact with these portable electronic devices' housings. Typical staining agents include: makeup (such as lipstick, lip gloss, lip liner, lip balm etc.), natural colorants (such as those found in soft drinks, coffee, red wine, mustard, ketchup, curry, etc.) and pen oil etc.

US20130231431A disclosed stain- or dye-resistant articles comprising a polymer composition comprising at least one semi-aromatic polyamide comprising recurring units resulting from the condensation of terephthalic acid and at least one aliphatic diamine comprising more than 8 carbon atoms, at least one filler and from 0.1 to 35 wt. % of at least one white pigment, based on the total weight of the composition.

US 20140179849A disclosed the use of a polyamide molding composition to produce a stain-resistant article, the staining tendency of the article is at 2. The composition contains 30-100 wt. % of a polyamide or a polyamide mixture consisting of 50-100 wt. % of at least one amorphous and/or microcrystalline polyamide having a glass transition temperature of at least 100° C., based on 20-100 mol % of at least one cycloaliphatic diamine and 0-80 mol % of at least one aliphatic and/or aromatic diamine; and also aromatic and/or aliphatic dicarboxylic acids comprising at least 6 carbon atoms, and 0-50 wt. % of at least one semi-aromatic polyamide. In addition, 0-70 wt. % of fibrous fillers and/or particulate fillers, 0-3 wt. % of impact toughness modifier and/or polymers different from polyamide, 0-25 wt. % of a flame retardant, and 0-2 wt. % of additives may also be contained.

WO 2012049252A describes stain-resistant articles based on semi-aromatic, semi-crystalline, non-transparent polyamide molding composition having a high melting point, which derive from terephthalic acid and an aliphatic diamine comprising at least 8 carbon atoms. For example, PA 9T or PA 10T. In addition, these molding compositions necessarily contain a reinforcing agent and a white pigment.

WO2012049255A likewise describes articles, in particular casing for portable electronic devices, produced from semi-aromatic, semi-crystalline, non-transparent polyamides with a high melting point, which are to have high stain-resistance. The polyamides are based on the following monomers: terephthalic acid, isophthalic acid and aliphatic diamines comprising 6 carbon atoms. The molding composition likewise contain a reinforcing agent and a white pigment, in this case too, a whiteness of at least 70 is required. In the examples, it is shown that the molding composition based on the semi-crystalline, semi-aromatic polyamide PA 6T/6I has a lower staining tendency compared to the semi-crystalline polyamide molding compositions based on PA 66 and PA 6T/66.

The prior art documents did not disclose a polyamide composition having a good stain resistance on both curry and pen oil.

### SUMMARY

Present invention provides a stain-resistant polyamide composition comprising,

a) 55-80 wt. % of semi-crystalline semi-aromatic polyamide;

b) 5-15 wt. % of aliphatic polyamide;

c) 15-30 wt. % of amorphous semi-aromatic polyamide;

wherein the weight percentages of a), b) and c) are relative to the total weight of a), b) and c) and the sum of the weight percentages of a), b) and c) is 100 wt. %; and

wherein the semi-crystalline semi-aromatic polyamide comprises repeat units derived from condensation of terephthalic acid and at least one aliphatic diamine having more than 8 and less than 12 carbon atoms.

The effect of the polyamide composition according to the invention is that molded parts made thereof have a good stain resistance on both curry and pen oil. This is shown by different examples whereas similar compositions with either the aliphatic polyamide or the amorphous semi-aromatic polyamide show a significantly less good staining resistance. In this respect, the aliphatic polyamide and the amorphous semi-aromatic polyamide in the polyamide composition according to the invention have a positive synergistic effect on the stain resistance.

### Details

### Semi-Crystalline Semi-Aromatic Polyamide

The semi-crystalline semi-aromatic polyamide in the composition according to present invention comprises repeat units derived from condensation of terephthalic acid and at least one aliphatic diamine.

The repeat units are advantageously derived from the condensation of terephthalic acid and at least one aliphatic diamine comprising more than 8 carbon atoms. Preferably, these repeat units are derived from the condensation of terephthalic acid and at least one aliphatic diamine comprising less than 12 carbon atoms; most preferably, these repeat units are derived from the condensation of terephthalic acid and one or more aliphatic diamine comprising 9, 10, or 11 carbon atoms.

Preferably, the semi-crystalline semi-aromatic polyamide according to present invention is PA 9T, PA 10T, or PA 11T, or any mixture thereof. Most preferably, the semi-crystalline semi-aromatic polyamide according to present invention is PA 10T. Suitably, the PA 10T may be prepared by various ways. It is advantageously prepared at least partially from decanediamine derived from a renewable raw material such as castor bean.

The semi-crystalline semi-aromatic polyamide according to the present invention suitably has a melting point of above 200° C., preferably, above 240° C., more preferably above 280° C., and most preferably, above 300° C. Excellent result is obtained with a semi-aromatic polyamide with a melting point of 313° C.

The semi-crystalline semi-aromatic polyamide according to present invention is present in the polymer composition in an amount of 55-80 wt. %, preferably 60-75 wt. %, more preferably 65-70 wt. % relative to the total weight of the component a), b) and c).

### Aliphatic Polyamide

The polymer composition further comprises aliphatic polyamide. The aliphatic polyamide suitably results from condensation of aliphatic diamine and aliphatic dicarboxylic acid or from polymerization of a lactam.

For example, the aliphatic polyamide is one or more selected from the group consisting of polyamide 6, polyamide 6,6; polyamide 4,6; polyamide 6,10, polyamide 4,10; polyamide 6,12, polyamide 11, polyamide 12, polyamide 9,10; polyamide 9,12, polyamide 9,13, polyamide 9,15, polyamide 6,16, polyamide 9,16, polyamide 10,10, polyamide 10,12, polyamide 10,13, polyamide 10,1, polyamide 9,15, polyamide 10, 12, polyamide 10,13, polyamide 10,14, polyamide 12,10, polyamide 12,12, polyamide 12,13, polyamide 12,14, polyamide 6,14, polyamide 6,13, polyamide 6,15, polyamide 6,16; preferably the aliphatic polyamide is one or more of polyamide 4,6, polyamide 6,10, polyamide 4,10, polyamide 6,12, and any copolymers thereof; more preferably, the aliphatic polyamide is polyamide 4,10.

The aliphatic polyamide may be present in the composition in an amount of 5-15 wt. %, preferably 8-12 wt. %, more preferably 9-10 wt. % relative to the total amount of the component a), b) and c).

### Amorphous Semi-Aromatic Polyamide

Further to the above mentioned semi-crystalline semi-aromatic polyamide and the aliphatic polyamide, the composition disclosed in present invention also comprises an amorphous semi-aromatic polyamide which is an amorphous semi-aromatic polyamide.

The amorphous semi-aromatic polyamide is preferably based on straight-chain and/or branched aliphatic diamines and aromatic dicarboxylic acids. With regards to the amorphous semi-aromatic polyamides, the systems polyamide DT/DI in which D is 2-methyl-1,5-pentamethylenediamine, polyamide 6I/6T or polyamide 10I/10T are preferred and polyamide 6I/6T is more preferred. The polyamide 6I/6T is a copolymer of polyamide resulting from terephthalic acid and 1, 6-hexanediamine and polyamide resulting from isophthalic acid and 1, 6-hexanediamine. Amorphous polyamide 10I/10T is a copolymer of polyamide resulting from isophthalic acid, terephthalic acid and 1,10-decanediamine, preferably with excess isophthalic acid over terephthalic acid.

In a preferred embodiment, in the polyamide 6I/6T or polyamide 10I/10T system, it has a proportion of less than 50 mol % of 6T or 10T units respectively; wherein the molar ratio of 6T to 6I in the copolyamide of polyamide 6I/6T, or the ratio of 10T to 10I in the copolyamide 10I/10T is from 20:80 to 45:55, in particular from 25:75 to 40:60 is preferred.

The amount of the amorphous semi-aromatic polyamide present in present invention is 5-15 wt. %; preferably 8-12 wt. %; more preferably 10 wt. % relative to the total weight of the component a), b) and c).

### Pigment

The composition according to present invention may further comprise a pigment. The pigment could be with different color according to the different requirement. The pigment could be white pigment. The white pigment according to the present invention is preferably selected from titanium dioxide, barium sulfate, zinc sulfide, and mixtures thereof. More preferably, the white pigment is titanium dioxide or zinc sulfide.

The pigment is present in an amount of 1-10 wt. %; preferably 5-10 wt. %; more preferably 10 wt. % of relative to the total weight of the polyamide composition.

### Fibrous Reinforcing Filler

The composition may further comprise at least one fibrous reinforcing filler. The fibrous reinforcing agent may be glass fiber, carbon fiber, ceramic fiber or other materials. Glass fibers are preferred. The fibrous reinforcing agent may be in the form of long glass fiber, chopped strands, milled short glass fibers, or other suitable forms known to those skilled in the art. Particularly preferred according to the invention are glass fibers having a fiber diameter of 7-18 μm, preferably 9-15 μm, most preferably about 10 μm.

The amount of the fibrous reinforcing filler present in present invention is 1-55 wt. % preferably 20-55 wt. %; more preferably 30-50 wt. % relative to the total weight of the polyamide composition.

### Other Additives

The polyamide composition according present invention may further comprise some stain-resistant agent such as PTFE and/or silicones which will improve the stain resistant property. The stain-resistant agent, if present, may be in an amount of 0-10 wt. %, preferably, 2-8 wt. %, more preferably 3-6 wt. % relative to the total amount of the polyamide composition.

The polyamide composition may further comprise additional additives such as ultraviolet light stabilizers, heat stabilizers, antioxidants, processing aids, lubricants, flame retardant, mold release agent etc.

Present invention further provides an article, in particular, a frame or a housing, or a part of a frame or housing, for a portable electronic device for portable electronic devices, having improved stain-resistance. In addition, these articles have good mechanical properties, in particular, high rigidity, high strength, good impact toughness and high dimensional stability, and also good processing properties such as low molding shrinkage and low warping.

With the context of the invention, stain resistance means that the articles or casing in contact with dye stuffs used in daily life, such as in soft drinks, ketchup, red wine, mustard, especially, in curry and pen oil. Preferably, the obtained article has a ΔE values of 6 or less; more preferably has a ΔE value of 2 or less, most preferably, has a ΔE value of 1 or less, under the determination method of ASTM E 308.

The expressions of ‘above’, ‘below’, ‘within’, ‘higher than’, ‘less than’, ‘at least’, ‘no more than’, ‘not less than’, ‘in a range of’, ‘ranges from’ ‘more than’ before a number in present invention include the number itself.

### Technical Effect

Present invention thus provides a polyamide composition having surprisingly stain resistant behavior on both curry and pen oil and also having an excellent mechanical, physical and chemical properties such as low warpage and good flowability.

The patent invention will be described hereinafter with use of specific examples but will not be limited thereto.

### EXAMPLES

### Material

PA10T: M8000, from Evonik

PA410: EcoPaxx Q150, from DSM

PA6I/6T Selar 3426R, from DuPont

Glass fiber: Standard grade (chopped fibers length, diameter of 10 or 15 μm, for thermoplastic polyamide molding compositions)

ZnS: HDS

PTFE 3300D

MRA mold release agent

### Test Method

### REFERENCE

The sample without staining media (no curry, no pen oil) was used as reference. Before being stained, the L*, a*, b* values of the reference were determined by using a color meter-Konica Minolta MC3700d according the determination of ASTM E 308.

### Stained by Curry

The samples were painted by yellow Indian curry on the surface and stored for 1 hour at 50° C. with a relative humidity of 95%.

After storage, the colored plates were brought out and left under room temperature for 1 hour and then cleaned with aqueous soap solution until the sample surfaces were free from adhering residue of the curry.

### Stained by Pen Oil

The samples were drawn 5 lines on the surface by using an oil pen (MO-120-MC-BK, ZEBIFA oiliness), then stored for 1 hour at 50° C. with a relative humidity of 95%. After storage, the drawn plates were brought out and left under room temperature for 1 hour and then cleaned by a cloth dipped with alcohol for 10 times.

After cleaning, the L*, a*, b* values of test colored plates were determined by using a color meter-Konica Minolta CM3700d under the determination of ASTM E 308.

The color difference ΔE between the color locations (L*,a*,b*) reference and color locations (L*, a*, b*) sample was calculated in accordance the formula as follows,

$$ΔE = \sqrt{{( {L}_{sample}^{*} - {L}_{reference}^{*} )}^{2} + {( {a}_{sample}^{*} - {a}_{reference}^{*} )}^{2} + {( {b}_{sample}^{*} - {b}_{reference}^{*} )}^{2}} \qquad ( I )$$

The staining tendency (ST) in the described staining test was quantified by the value of color difference ΔE;

It can be classified as follows:

ST1: no staining or only very slight staining (0<ΔE≤2)-good

ST2: considerable staining (2<ΔE≤6)-medium

ST3: heavy staining (corresponds to an ΔE>6)-bad

Articles (molded parts, components) according to the invention have a staining tendency of class ST1 or ST2, that is to say the ΔE value is 6 at most.

### Examples

The compounding of the components of Examples 1-3 and comparative examples 1-5 as specified in table 1 were carried out in a twin-screw extruder using standard compounding conditions.

The sample plates were produced by injection molding of compounds using injection machine with a mold temperature of 140° C. and melt temperature of 335° C.

The values of L*, a*, b* of the reference, curry stained plates and the pen oil stained plates were measured according to the above-mentioned test method respectively and the color difference (ΔE) of the curry stained plates and the pen oil stained plates were obtained according to the calculation according of formula (I). The test results were listed in the table 1.

### CONCLUSION

As can be seen from table 1, comparing to the comparative examples, the polyamide compositions obtained by examples 1,2,3 have a very lower value of the color difference (ΔE) on both of curry resistance and pen oil resistance.

TABLE 1

| | | | | Comparative | Comparative | Comparative | Comparative | Comparative |
|---|---|---|---|---|---|---|---|---|
| | Ex 1 | Ex 2 | Ex 3 | Ex1 | Ex2 | Ex3 | Ex4 | Ex5 |
| PA10T | 28 | 27.86 | 24.5 | 18 | 81 | 81 | 63 | 28 |
| PA410 | 4 | 3.98 | 3.5 | 18 | 9 | — | 27 | 12 |
| PA6I/6T | 8 | 7.96 | 7 | 4 | — | 9 | 0 | — |
| PTFE | — | — | 5 | — | — | — | — | — |
| Glass fiber | 50 | 50 | 50 | 50 | — | — | — | 50 |
| ZnS | 10 | 10 | 10 | 10 | 10 | 10 | 10 | 10 |
| MRA | — | 0.2 | — | — | — | — | — | — |
| Total | 100 | 100 | 100 | 100 | 100 | 100 | 100 | 100 |
| Curry resistance | | | | | | | | |
| L* | 94.91 | 94.98 | 94.08 | 95.1 | 97.01 | 96.78 | 96.95 | 94.96 |
| a* | −1.8 | −1.73 | −2 | −9.51 | −2.4 | −2.32 | −2.1 | −2.26 |
| b* | 3.68 | 3.3 | 6.55 | 21.72 | 4.65 | 4.75 | 4.28 | 4.35 |
| ΔE | 0.4 | 0.39 | 0.79 | 19.69 | 1.88 | 1.96 | 1.45 | 1.22 |
| Remark | Good | Good | Good | Bad | Good | Good | Good | Good |
| Pen oil resistance | | | | | | | | |
| L* | 90.35 | 91.64 | 91.02 | 84.61 | 88.37 | 80.64 | 68.58 | 77.74 |
| a* | −1.95 | −1.73 | −1.7 | −7.46 | −1.41 | −1.27 | −4.64 | −2.71 |
| b* | 0.98 | 1.42 | 4.43 | 22.34 | −1.11 | −4.34 | 1.84 | −1.18 |
| ΔE | 5.4 | 4.1 | 3.77 | 22.31 | 9.18 | 17.21 | 28.39 | 17.69 |
| Remark | Medium | Medium | Medium | Bad | Bad | Bad | Bad | Bad |

1. A stain-resistant polyamide composition comprising,
a) 55-80 wt. % of semi-crystalline semi-aromatic polyamide;
b) 5-15 wt. % of aliphatic polyamide;
c) 15-30 wt. % of amorphous semi-aromatic polyamide;
wherein the weight percentages of a), b) and c) are relative to the total weight of a), b) and c) and the sum of the weight percentages of a), b) and c) is 100 wt. %; and
wherein the semi-crystalline semi-aromatic polyamide comprises repeat units derived from condensation of terephthalic acid and at least one aliphatic diamine having more than 8 and less than 12 carbon atoms.

2. The stain-resistant polyamide composition according to claim 1, wherein the composition further comprises d) 1-55 wt. % of fibrous reinforcing filler relative to the total weight of the composition.

3. The stain-resistant polyamide composition according to claim 1, wherein the composition further comprises e) 1-10 wt. % of white pigment relative to the total weight of the composition.

4. The stain-resistant polyamide composition according to claim 1, wherein semi-crystalline semi-aromatic polyamide is PA9T, PA10T, or PA11T, or any mixture thereof.

5. The stain-resistant polyamide composition according to claim 1, wherein the aliphatic polyamide comprises repeat units derived from condensation of aliphatic diamine and aliphatic dicarboxylic acid or from polymerization of a lactam.

6. The stain-resistant polyamide composition according to claim 5, wherein the aliphatic polyamide is one or more selected from the groups consisting of polyamide 6, polyamide 6,6; polyamide 4,6; polyamide 6,10, polyamide 4,10; polyamide 6,12, polyamide 11, polyamide 12, polyamide 9,10; polyamide 9,12, polyamide 9,13, polyamide 9,15, polyamide 6,16, polyamide 9,16, polyamide 10,10, polyamide 10,12, polyamide 10,13, polyamide 10,1, polyamide 9,15, polyamide 10, 12, polyamide 10,13, polyamide 10,14, polyamide 12,10, polyamide 12,12, polyamide 12,13, polyamide 12,14, polyamide 6,14, polyamide 6,13, polyamide 6,15, polyamide 6,16; preferably the aliphatic polyamide is polyamide 4,6, polyamide 6,10, polyamide 4,10, polyamide 6,12; and any copolymers thereof, more preferably, the aliphatic polyamide is polyamide 4,10.

7. The stain-resistant polyamide composition according to claim 6, wherein the amorphous semi-aromatic polyamide is polyamide 6I/6T or polyamide DT/DI, or a mixture thereof.

8. The stain-resistant polyamide composition according to claim 2 wherein the fibrous reinforcing filler includes glass fiber and/or carbon fiber.

9. The stain-resistant polyamide composition according to claim 8, wherein the fibrous reinforcing filler is glass fiber.

10. The stain-resistant polyamide composition according to claim 3, wherein the white pigment is selected from titanium dioxide, barium sulfate, zinc sulfide, and mixtures thereof; preferably, the pigment is titanium dioxide or zinc sulfide.

11. An article made of the stain-resistant polyamide composition according claim 1.

12. The article according to claim 11, wherein the article is a frame or a housing, or a part of a frame or housing, for a portable electronic device.
